(19) United States
(12) Patent Application Publication
(10) Pub. No.: US 2024/0253638 A1
(43) Pub. Date: Aug. 1, 2024

(54) VEHICLE CONTROL DEVICE, STORAGE MEDIUM STORING COMPUTER PROGRAM FOR CONTROLLING VEHICLE, AND METHOD FOR CONTROLLING VEHICLE

(71) Applicant: TOYOTA JIDOSHA KABUSHIKI KAISHA, Toyota-shi Aichi-ken (JP)

(72) Inventor: Wataru Kawashima, Nisshin-shi Aichi-ken (JP)

(73) Assignee: TOYOTA JIDOSHA KABUSHIKI KAISHA, Toyota-shi Aichi-ken (JP)

(21) Appl. No.: 18/421,126

(22) Filed: Jan. 24, 2024

(30) Foreign Application Priority Data
Jan. 26, 2023 (JP) 2023-010222

(51) Int. Cl. B60W 30/182; B60R 21/01; B60R 21/0136; B60R 21/015; B60R 21/16; B60R 21/38; B60W 30/14

(52) U.S. Cl. CPC B60W 30/182; B60R 21/0136; B60R 21/01558; B60R 21/16; B60R 21/38; B60W 30/146; B60R 2021/01211; B60W 2420/54; B60W 2556/20

(57) ABSTRACT

A vehicle control device has a processor configured to detect collision sound produced by collision between a vehicle and an object based on a sound signal acquired from a sound sensor and calculate reliability of the detected collision sound, determine whether the reliability is at or above a first reference value, determine whether a driving mode of the vehicle is a first driving mode in which a degree to which a driver participates in driving is low, or a second driving mode in which the degree to which the driver participates in driving is higher than the first driving mode, and decide to transfer the driving mode of the vehicle to the second driving mode when it has been determined that the reliability is at or above the first reference value and it has been determined that the driving mode of the vehicle is the first driving mode.

### CROSS-REFERENCE TO RELATED APPLICATIONS

This application claims priority to Japanese Patent Application No. 2023-010222 filed on Jan. 26, 2023, the entire contents of which are herein incorporated by reference.

### FIELD

The present disclosure relates to a vehicle control device, to a storage medium storing a computer program for controlling a vehicle, and to a method for controlling a vehicle.

### BACKGROUND

An automatic control system mounted in a vehicle has, for example, a self-driving mode in which the vehicle is driven primarily by the automatic control system and manual driving mode in which the vehicle is driven primarily by the driver. In self-driving mode, some or all of the driving operations necessary for traveling of the vehicle are executed automatically, thus lowering the degree to which the driver participates in driving. In manual driving mode, the types of driving operations executed automatically are less than in self-driving mode, or zero, and therefore the degree to which the driver participates in driving is high.

The vehicle has a sensor that detects collision with objects. For example, pressure sensors and acceleration sensors are used as sensors to detect collision of the vehicle with objects (see Japanese Unexamined Patent Publication No. 2019-181989, for example). Depending on the location where a pressure sensor is installed, it may not be able to detect a collision of an object with the vehicle. An acceleration sensor is used to detect relatively large collisions that require deployment of an airbag.

When the vehicle has collided with a small object, this may not be detected with a pressure sensor or acceleration sensor. Collisions of the vehicle with small objects are therefore detected by detecting the sounds of the collisions. A collision sound is detected using a classifier trained by machine learning, for example. When the classifier detects a potential collision sound, it outputs the reliability as to whether the detected sound is a collision sound.

### SUMMARY

When an automatic control system detects that the vehicle has collided with an object, it brakes the vehicle to cause deceleration or stopping.

Objects that collide with vehicles also include small objects such as small stones. In order to accurately detect collisions of the vehicle with such small objects, it may be determined that the vehicle has collided with an object only when a collision sound has been detected with a reliability at or above a predetermined reference value.

When the vehicle is decelerated or stopped after the vehicle has collided with a small object such as a small stone, the potential effect on traveling of other vehicles following the vehicle may outweigh the need to ensure safety for the vehicle. It is considered desirable for the driver to have the discretion to take action when the vehicle has collided with an object.

It is an object of the present disclosure to provide a vehicle control device that can detect when a vehicle has collided with a small object based on collision sound produced on the vehicle, and that allows the driver to take action in response to collision between the vehicle and the object.

(1) One embodiment of the present disclosure provides a vehicle control device. The vehicle control device has a sound detecting unit that detects collision sound produced by collision between a vehicle and an object based on a sound signal acquired from a sound sensor, and calculates reliability of the detected collision sound, a first determining unit that determines whether the reliability calculated by the sound detecting unit is at or above a first reference value, a second determining unit that determines whether a driving mode of the vehicle is a first driving mode in which a degree to which a driver participates in driving is low, or a second driving mode in which the degree to which the driver participates in driving is higher than the first driving mode, and a deciding unit that decides to transfer the driving mode of the vehicle to the second driving mode when it has been determined by the first determining unit that the reliability is at or above the first reference value and it has been determined by the second determining unit that the driving mode of the vehicle is the first driving mode.

(2) The vehicle control device of (1) above also has a third determining unit that determines whether the reliability calculated by the sound detecting unit is at or above a second reference value that is larger than the first reference value, and when it has been determined by the first determining unit that the reliability is at or above the first reference value, it has been determined by the second determining unit that the driving mode of the vehicle is the first driving mode and it has been determined by the third determining unit that the reliability of the collision sound is at or above the second reference value, the deciding unit decides to decelerate the vehicle.

(3) The vehicle control device of (1) above also has a fourth determining unit that determines whether intensity of the collision sound is at or above a third reference value, based on the sound signal acquired from the sound sensor, and when it has been determined by the first determining unit that the reliability is at or above the first reference value, it has been determined by the second determining unit that the driving mode of the vehicle is the first driving mode and it has been determined by the fourth determining unit that the intensity of the collision sound is at or above the third reference value, the deciding unit decides to deploy an airbag or to move the front hood from the stop position to a lifted position.

(4) The vehicle control device of (1) above also has a fifth determining unit that determines whether intensity of the collision sound is at or below a fourth reference value, based on the sound signal acquired from the sound sensor, and when it has been determined by the first determining unit that the reliability is at or above the first reference value, it has been determined by the second determining unit that the driving mode of the vehicle is the first driving mode and it has been determined by the fifth determining unit that the intensity of the collision sound is at or below the fourth reference value, the deciding unit decides to transfer the driving mode of the vehicle to the second driving mode.

(5) According to another embodiment, a non-transitory storage medium storing a computer program for controlling a vehicle is provided. The computer program for vehicle control causes a processor to execute a process, and the process includes detecting collision sound produced by collision between a vehicle and an object based on a sound signal acquired from a sound sensor, and calculating reliability of the detected collision sound, determining whether the reliability is at or above a first reference value, determining whether a driving mode of the vehicle is a first driving mode in which a degree to which a driver participates in driving is low, or a second driving mode in which the degree to which the driver participates in driving is higher than the first driving mode, and deciding to transfer the driving mode of the vehicle to the second driving mode when it has been determined that the reliability is at or above the first reference value and it has been determined that the driving mode of the vehicle is the first driving mode.

(6) Another embodiment of the present disclosure provides a method for controlling a vehicle. The method for controlling a vehicle is carried out by a vehicle control device and includes detecting collision sound produced by collision between a vehicle and an object based on a sound signal acquired from a sound sensor, and calculating reliability of the detected collision sound, determining whether the reliability is at or above a first reference value, determining whether a driving mode of the vehicle is a first driving mode in which a degree to which a driver participates in driving is low, or a second driving mode in which the degree to which the driver participates in driving is higher than the first driving mode, and deciding to transfer the driving mode of the vehicle to the second driving mode when it has been determined that the reliability is at or above the first reference value and it has been determined that the driving mode of the vehicle is the first driving mode.

The vehicle control device of the present disclosure allows detection of even a collision of a small object with the vehicle based on the collision sound produced on the vehicle, and upon detection of the collision sound, transfers to a driving mode in which the degree to which the driver participates in driving is high, to allow the driver to take action in response to the collision between the vehicle and the object.

The object and aspects of the present disclosure will be realized and attained by the elements and combinations particularly indicated in the claims. It is to be understood that both the foregoing general description and the following detailed description are exemplary and explanatory and are not restrictive of the present disclosure, as claimed.

### BRIEF DESCRIPTION OF DRAWINGS

FIG. 1 is a diagram illustrating operation of an automatic control device of the first embodiment in overview.

FIG. 2 is a general schematic drawing of a vehicle in which an automatic control system is mounted that has an automatic control device of the first embodiment.

FIG. 3 is an example of an operation flow chart for vehicle control processing by the automatic control device of the first embodiment.

FIG. 4 is an example of an operation flow chart for vehicle control processing by the automatic control device of the second embodiment.

FIG. 5 is an example of an operation flow chart for vehicle control processing by the automatic control device of the third embodiment.

FIG. 6 is an example of an operation flow chart for vehicle control processing by the automatic control device of the fourth embodiment.

### DESCRIPTION OF EMBODIMENTS

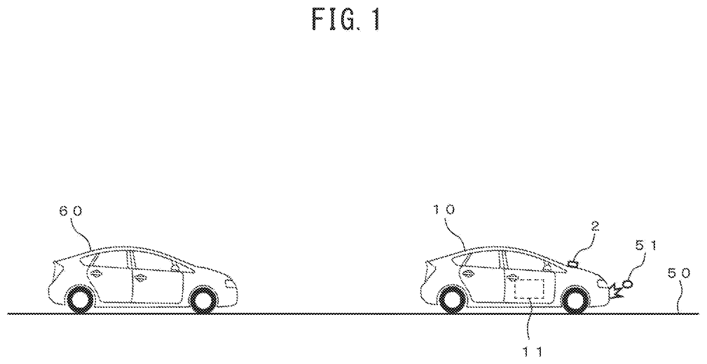

FIG. 1 is a diagram illustrating operation of an automatic control device 11 of the first embodiment in overview. Operation relating to vehicle control processing by the automatic control device 11 disclosed herein will now be described in overview with reference to FIG. 1.

The vehicle 10 has a microphone 2 and an automatic control device 11. The automatic control device 11 controls operation of the vehicle 10 according to two driving modes with different degrees of driver participation for driving. The microphone 2 is an example of a sound sensor. The automatic control device 11 is an example of a vehicle control device. The vehicle 10 may also be an autonomous vehicle.

For example, the automatic control device 11 has a self-driving mode in which the degree to which the driver participates in driving is low (for example, driving mode with levels 3 to 5) and a manual driving mode in which the degree to which the driver participates in driving is high (for example, driving mode with levels 0 to 2). The self-driving mode is an example of the first driving mode. The manual driving mode is an example of the second driving mode.

In self-driving mode, the vehicle 10 is driven primarily by the automatic control device 11. In manual driving mode, the vehicle 10 is driven primarily by the driver (not shown). In the example shown in FIG. 1, the vehicle 10 travels on a road 50 in self-driving mode. Another vehicle 60 is traveling behind the vehicle 10.

The microphone 2 is installed on the outer side of the vehicle 10. The microphone 2 inputs sounds from around the vehicle 10. The microphone 2 converts the input sound into a sound electrical signal and outputs it to the automatic control device 11.

In the example shown in FIG. 1, the vehicle 10 collides with a small stone 51. The microphone 2 inputs the collision sound produced by the collision.

Based on the sound electrical signal acquired from the microphone 2, the automatic control device 11 detects the collision sound produced by collision between the vehicle 10 and the small stone 51, and calculates the reliability of the detected collision sound. When the reliability is at or above the first reference value, the automatic control device 11 estimates that the vehicle 10 has collided with an object.

Since the reliability is at or above the first reference value and the driving mode of the vehicle 10 is self-driving mode, the automatic control device 11 decides to transfer the driving mode of the vehicle 10 to manual driving mode.

The automatic control device 11 transfers the driving mode of the vehicle 10 from self-driving mode to manual driving mode. In manual driving mode, the vehicle 10 begins to be driven primarily by the driver.

In some embodiments, when the vehicle 10 has collided with another vehicle, deceleration or stopping of the vehicle 10 may be desirable from the viewpoint of ensuring safety of the vehicle 10. However, when the vehicle 10 is decelerated or stopped after the vehicle 10 has collided with even a small object such as a small stone 51, the potential effect on traveling of another vehicle 60 following the vehicle 10 may outweigh ensuring safety for the vehicle 10.

The automatic control device 11 therefore transfers driving of the vehicle 10 from self-driving mode to manual driving mode when the reliability is at or above the first reference value. In manual driving mode, the driver judges the conditions of the vehicle 10 and its surroundings. The driver also drives the vehicle 10 based on the results of their own judgment.

In the example shown in FIG. 1, the driver determines that the vehicle 10 has collided with a small object such as a small stone. The driver continues driving of the vehicle 10 without decelerating the vehicle 10. The vehicle 60 following the vehicle 10 may also continue traveling without lowering speed.

As explained above, the automatic control device 11 of the embodiment can detect when a vehicle 10 has collided even with a small object, based on collision sound produced on the vehicle 10, allowing the driver to take action in response to collision between the vehicle 10 and the object.

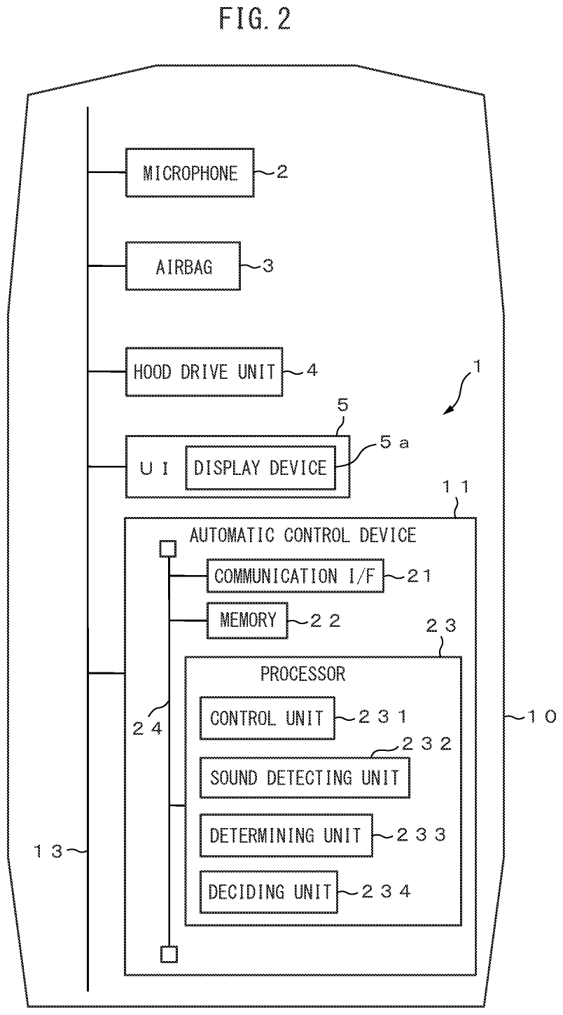

FIG. 2 is a general schematic drawing of a vehicle 10 in which a vehicle control system 1 is mounted that comprises an automatic control device 11 of the embodiment. The vehicle 10 has a microphone 2, an airbag 3, a hood drive unit 4, a user interface (UI) 5 and the automatic control device 11. The vehicle control system 1 includes at least the microphone 2 and the automatic control device 11.

The microphone 2, airbag 3, hood drive unit 4, UI 5 and automatic control device 11 are connected in a communicable manner via an in-vehicle network 13 conforming to the Controller Area Network standard.

The microphone 2 is an example of a sound sensor. The microphone 2 is installed on the outer side of the vehicle 10, for example, allowing input of sounds from outside of the vehicle 10. The microphone 2 inputs collision sounds produced when objects have collided with the vehicle 10. Examples of collision sounds include collision sounds between the vehicle 10 and small objects such as small stones, collision sounds between the vehicle 10 and moving objects such as other vehicles, and collision sounds between the vehicle 10 and stationary objects such as guard rails.

The microphone 2 converts the input sound into a sound electrical signal and outputs the sound electrical signal to the automatic control device 11 via the network 13. Only one microphone 2 is shown in the example shown in FIG. 2, but a plurality of microphones may also be installed in the vehicle 10.

The airbag 3 ensures safety for passengers including the driver by deploying under the control of the automatic control device 11. The airbag 3 is installed in the driving seat of the vehicle 10. Only one airbag 3 is shown in the example shown in FIG. 2, but an airbag may also be installed in the passenger seat or back seat.

The hood drive unit 4 is controlled by the automatic control device 11 to drive the front hood (not shown) of the vehicle 10. The front hood will usually cover the engine/motor compartment in which the engine or motor is situated, from the front end toward the cabin end of the vehicle 10. The edge at the cabin end of the front hood is located at the stop position. The hood drive unit 4 moves the cabin end part of the front hood upward from the stop position to a lifted position, forming a space between the front hood and the engine/motor compartment. This allows the front hood to be deformed toward the engine compartment side. Even if the head of a pedestrian that has collided with the vehicle 10 hits against the front hood, deformation of the front hood toward the engine/motor compartment side alleviates the impact received by the head.

The UI 5 is an example of a notification unit. The UI 5, controlled by the automatic control device 11, for example, notifies the driver of operating information relating to the vehicle 10. The operating information relating to the vehicle 10 includes traveling information for the vehicle 10, and transfer requests for requesting transfer of the driving mode of the vehicle 10 from self-driving mode to manual driving mode. The UI 5 has a display device 5a such as a liquid crystal display or touch panel, for display of the operating information. The UI 5 may also have an acoustic output device (not shown) to notify the driver of operating information. The UI 5 also has a touch panel or operating button, for example, as an input device for inputting operation information from the driver to the vehicle 10. The operation information may be, for example, a destination location, transit points, vehicle speed, or a request for transfer of driving mode. The UI 5 outputs the input operation information to the automatic control device 11 via the in-vehicle network 13.

The automatic control device 11 carries out control processing, sound detection processing, determination processing and decision processing. For this purpose, the automatic control device 11 has a communication interface (IF) 21, a memory 22 and a processor 23. The communication IF 21, the memory 22 and the processor 23 are connected via a signal wire 24. The communication IF 21 has an interface circuit to connect the automatic control device 11 with the in-vehicle network 13.

The memory 22 is an example of a memory unit, and it has a volatile semiconductor memory and a non-volatile semiconductor memory, for example. The memory 22 stores an application computer program and various data to be used for information processing carried out by the processor 23 of each device.

All or some of the functions of the automatic control device 11 are carried out by functional modules driven by a computer program operating on the processor 23, for example. The processor 23 has a control unit 231, a sound detecting unit 232, a determining unit 233 and a deciding unit 234. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphic processing unit.

The control unit 231 controls operation including traveling of the vehicle 10. The control unit 231 has two driving modes with different degrees of driver participation for driving. The control unit 231 controls the operation of the vehicle 10 according to the driving mode.

For example, the control unit 231 has a self-driving mode in which the degree to which the driver participates in driving is low (for example, driving mode with levels 3 to 5) and a manual driving mode in which the degree to which the driver participates in driving is high (for example, driving mode with levels 0 to 2). In self-driving mode, the vehicle 10 is driven primarily by the automatic control device 11. In manual driving mode, the vehicle 10 is driven primarily by the driver. The control unit 231 notifies the determining unit 233 of mode information indicating the current driving mode.

In the driving mode in which the degree to which the driver participates in driving is low, all or some of the driving operations necessary for traveling of the vehicle 10 are executed automatically, while in the driving mode in which the degree to which the driver participates in driving is high, the types of driving operations executed automatically are less than in the driving mode in which the degree to which the driver participates in driving is low, or are zero.

In self-driving mode, the control unit 231 generates a driving plan to control actions such as steering, engine actuation and braking based on map information and on detection information from sensors (not shown) mounted in the vehicle 10. The control unit 231 outputs the automatic control signal based on the driving plan, to an actuator (not shown) that controls the steering wheel, a drive unit (not shown), or the brake (not shown), via the in-vehicle network 13.

In manual driving mode, the control unit 231 generates a manual control signal to control operation of the vehicle 10 such as steering, actuation and braking based on driver operation, and outputs the manual control signal to an actuator for actuation of the steering wheel, and to a drive unit or brake, via the in-vehicle network 13.

The control unit 231 can drive the vehicle 10 in self-driving mode in regions where self-driving mode is permitted (for example, regions where a high-precision map has been prepared for control of the vehicle 10). In regions where self-driving mode is not permitted, the control unit 231 controls the vehicle 10 in manual driving mode. In response to a driver request, the control unit 231 transfers from self-driving mode to manual driving mode or from manual driving mode to self-driving mode. The control unit 231 also transfers from self-driving mode to manual driving mode when it has determined that the vehicle 10 cannot be safely driven in self-driving mode.

The automatic control device 11 is an electronic control unit (ECU), for example. In FIG. 2, the automatic control device 11 has the control unit 231, sound detecting unit 232, determining unit 233 and deciding unit 234 constructed as an integral device, but the control unit 231 may also be constructed as separated device from the sound detecting unit 232, determining unit 233 and deciding unit 234.

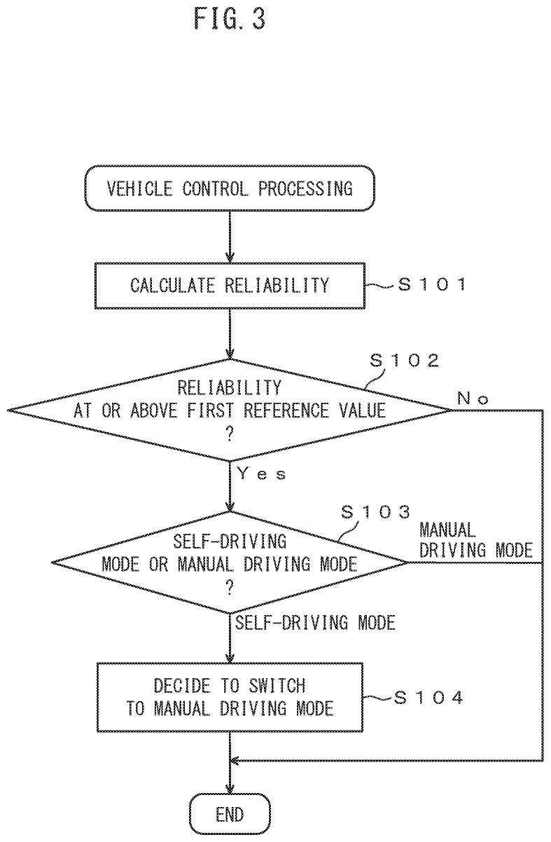

FIG. 3 is an example of an operation flow chart for vehicle control processing by the automatic control device 11 of the embodiment. Vehicle control processing by the automatic control device 11 will be described below with reference to FIG. 3. The automatic control device 11 carries out vehicle control processing according to the operation flow chart shown in FIG. 3, at a vehicle control time having a predetermined cycle.

First, based on the sound electrical signal acquired from the microphone 2, the sound detecting unit 232 detects the collision sound produced by collision between the vehicle 10 and an object, and calculates the reliability of the detected collision sound (step S101). The impact energy is converted to sound, thereby generating a relatively intense collision sound even when the vehicle 10 has collided with a small object, and therefore the sensitivity for detecting collisions between the vehicle 10 and small objects is higher than by a pressure sensor or acceleration sensor.

The sound detecting unit 232 has a classifier trained so as to identify collision sounds based on sound electrical signals. The classifier used may be, for example, a convolutional neural network (CNN) or a recurrent neural network (RNN) pre-trained so as to detect electrical signals representing collision sounds from among sound electrical signals. The sound detecting unit 232 inputs a sound electrical signal acquired from the microphone 2 into the classifier trained to distinguish electrical signals representing collision sounds, which detects an electrical signal representing a collision sound among the sound electrical signals and outputs the reliability of the detected collision sound. The reliability is represented as a real number between 0 and 1, for example. The closer the numerical value is to 1, the higher the reliability that an electrical signal representing a collision sound is included among the sound electrical signals.

In some embodiments, the classifier is trained using teacher data including many types of collision sounds. In some embodiments, the teacher data also includes collision sounds with different frequency and waveform types. In some embodiments, the teacher data also includes collision sounds of different intensities. The method of calculating the reliability of collision sounds is not limited to using the classifier described above. Other publicly known technologies may also be used to calculate the reliability of collision sounds.

The determining unit 233 then determines whether or not the reliability is at or above the first reference value (step S102). The first reference value may be in the range of 0.6 to 0.8, for example. When the reliability is at or above the first reference value, the automatic control device 11 estimates that the vehicle 10 has collided with an object. The determining unit 233 is an example of the first determining unit. The determining unit 233 may also determine the reliability calculated between the current vehicle control time and the immediate previous vehicle control time.

When the reliability is at or above the first reference value (step S102-Yes), the determining unit 233 determines either that the driving mode of the vehicle 10 is self-driving mode in which the degree to which the driver participates in driving is low, or manual driving mode in which the degree to which the driver participates in driving is lower than in self-driving mode (step S103). When the mode information indicates self-driving mode, the determining unit 233 determines that the driving mode of the vehicle 10 is self-driving mode. When the mode information indicates manual driving mode, the determining unit 233 determines that the driving mode of the vehicle 10 is manual driving mode. The determining unit 233 is an example of the second determining unit.

When the driving mode of the vehicle 10 is self-driving mode (step S103-self-driving mode), the deciding unit 234 decides to transfer the driving mode of the vehicle 10 from self-driving mode to manual driving mode (step S104), and the series of processing steps is complete.

The deciding unit 234 notifies the driver, via the UI 5, of a transfer request for requesting transfer of the driving mode of the vehicle 10 from self-driving mode to manual driving mode. The deciding unit 234 may also notify the driver via the UI 5 that the vehicle 10 has collided with an object, in tandem with the transfer request.

After having confirmed an acknowledgement action whereby the transfer request is acknowledged by the driver, the control unit 231 initiates manual driving mode. The acknowledgement action may be, for example, operation of the accelerator pedal (not shown) or brake pedal (not shown) while holding the steering wheel (not shown). If an acknowledgement action whereby the transfer request is acknowledged by the driver is not confirmed within a predetermined time period, the control unit 231 may stop the vehicle 10.

When driving of the vehicle 10 is initiated in manual driving mode, the driver judges the conditions of the vehicle 10 and its surroundings. When it has been judged that the vehicle 10 has collided with a small object such as a small stone 51, the driver may allow the vehicle 10 to travel without decelerating or stopping the vehicle 10. If the vehicle 10 is decelerated or stopped after the vehicle 10 has collided with only a small object such as a small stone 51, the potential effect on traveling of another vehicle 60 following the vehicle 10 may outweigh ensuring safety for the vehicle 10.

However, in some embodiments, the driver decelerates or stops the vehicle 10 when it has been judged that the vehicle 10 has collided with an object larger than a small stone. For example, in some embodiments, the driver stops the vehicle 10 and confirms the safety of the vehicle 10 and the surroundings of the vehicle 10.

The vehicle 10 can potentially collide with a large variety of objects. Therefore, when the automatic control device 11 has determined that the vehicle 10 has collided with an object, it transfers main driving of the vehicle 10 to the driver, for judgment of the conditions by the driver.

When the reliability is not at or above the first reference value (step S102-No), or when the driving mode of the vehicle 10 is manual driving mode (step S103-manual driving mode), the series of processing steps is complete. When the reliability is not at or above the first reference value, it is estimated that the vehicle 10 has not collided with an object. The driver likewise judges the conditions of the vehicle 10 and its surroundings when the driving mode of the vehicle 10 is manual driving mode.

As explained above, the automatic control device of the embodiment can detect when a vehicle has collided with a small object based on collision sound produced on the vehicle, allowing the driver to take action in response to collision between the vehicle and the object.

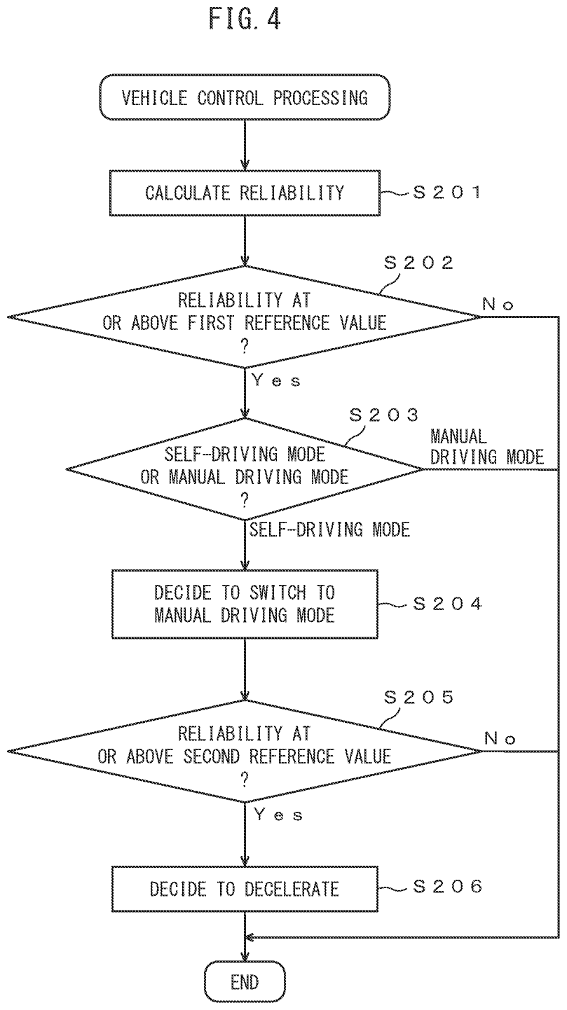

Operation of the automatic control device of the second to fourth embodiments disclosed herein will now be explained with reference to FIGS. 4 to 6.

FIG. 4 is an example of an operation flow chart for vehicle control processing by the automatic control device of the second embodiment. Vehicle control processing by the automatic control device 11 will be described below with reference to FIG. 4. The automatic control device 11 carries out vehicle control processing according to the operation flow chart shown in FIG. 4, at a vehicle control time having a predetermined cycle.

Processing in steps S201 to S204 of this embodiment is the same as in steps S101 to S104 described above. For the embodiment, the processing of steps S205 and S206 is added to the operation of the first embodiment.

When the deciding unit 234 has decided to transfer the driving mode of the vehicle 10 from self-driving mode to manual driving mode (step S204), the determining unit 233 determines whether or not the reliability calculated by the sound detecting unit 232 is at or above the second reference value that is larger than the first reference value (step S205). The second reference value may be in the range of 0.8 to 0.9, for example. The determining unit 233 is an example of a third determining unit.

When the reliability is at or above the second reference value (step S205-Yes), the deciding unit 234 decides to decelerate the vehicle 10 (step S206), and the series of processing steps is complete.

Greater intensity of a collision sound tends to correspond to greater reliability. Therefore, greater reliability is associated with larger objects colliding with the vehicle 10. For this embodiment, the deciding unit 234 decides to decelerate the vehicle 10 when the reliability is at or above the second reference value. This can ensure safety for the vehicle 10.

The deciding unit 234 notifies the control unit 231 that the vehicle 10 is to be decelerated. The control unit 231 decelerates the vehicle 10 either by using the brake or by stopping acceleration. The control unit 231 may also stop the vehicle 10.

When the reliability is not at or above the first reference value (step S202-No), or when the driving mode of the vehicle 10 is manual driving mode (step S203-manual driving mode), or when the reliability is not at or above the second reference value (step S205-No), the series of processing steps is complete.

As explained above, the automatic control device of this embodiment can ensure safety of the vehicle 10 by decelerating the vehicle 10 when the reliability is at or above the second reference value. The automatic control device of this embodiment exhibits the same effect as the first embodiment.

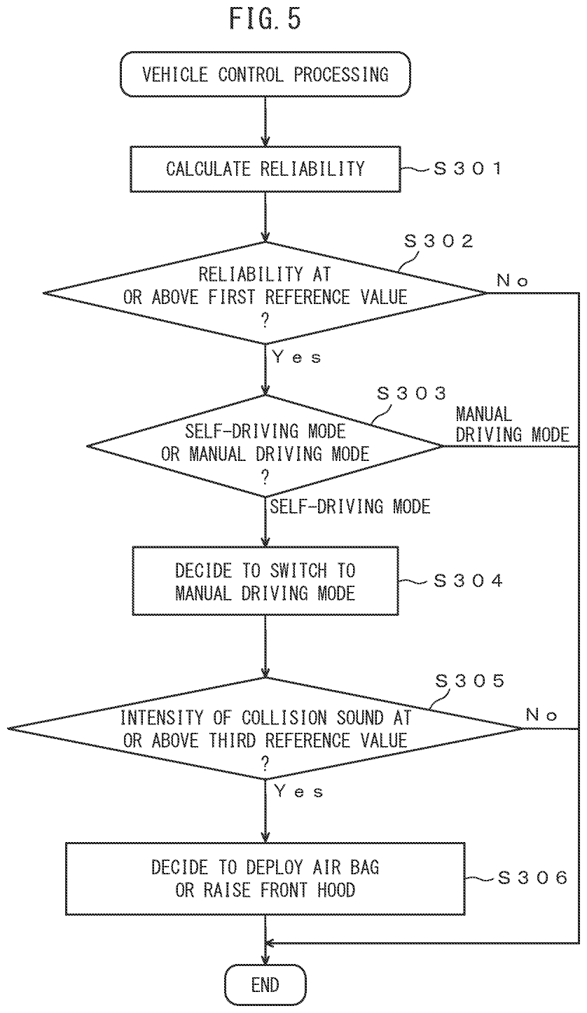

FIG. 5 is an example of an operation flow chart for vehicle control processing by the automatic control device of the third embodiment. Vehicle control processing by the automatic control device 11 will be described below with reference to FIG. 5. The automatic control device 11 carries out vehicle control processing according to the operation flow chart shown in FIG. 5, at a vehicle control time having a predetermined cycle.

Processing in steps S301 to S304 of this embodiment is the same as steps S101 to S104 described above. For the embodiment, the processing of steps S305 and S306 is added to the operation of the first embodiment.

When the deciding unit 234 has decided to transfer the driving mode of the vehicle 10 from self-driving mode to manual driving mode (step S304), the determining unit 233 determines whether or not the intensity of the collision sound is at or above the third reference value based on the sound electrical signal acquired from the microphone 2 (step S305). The third reference value may be 90 decibels, for example. A publicly known technology may also be used to calculate the intensity of the collision sound based on the sound electrical signal. The determining unit 233 is an example of a fourth determining unit.

The intensity of the collision sound is based on the relative speeds of the vehicle 10 and the collided object, and the mass of the object. The intensity of the collision sound is greater with a higher relative speed. The intensity of the collision sound is also greater with a larger mass of the object.

When the intensity of the collision sound is at or above the third reference value (step S305-Yes), the deciding unit 234 decides to either deploy the airbag 3, or to move the front hood from the stop position to the lifted position (step S306), and the series of processing steps is complete.

The deciding unit 234 may also decide to both deploy the airbag 3 and move the front hood from the stop position to the lifted position.

When the intensity of the collision sound is at or above the third reference value, it is estimated that the relative speed is high and/or that the mass of the collided object is large. By deploying the airbag 3, the deciding unit 234 ensures safety for passengers including the driver. The deciding unit 234 also ensures safety for a pedestrian that has collided with the vehicle 10, by moving the front hood from the stop position to the lifted position.

When it has been decided to deploy the airbag 3, the deciding unit 234 outputs to the airbag 3 a deployment signal for deployment of the airbag 3, via the in-vehicle network 13.

When it has been decided to move the front hood from the stop position to the lifted position, the deciding unit 234 outputs to the hood drive unit 4 a driving signal to drive the hood, via the in-vehicle network 13.

When the reliability is not at or above the first reference value (step S302-No), or when the driving mode of the vehicle 10 is manual driving mode (step S303-manual driving mode), or when the intensity of the collision sound is not at or above a third reference value (step S305-No), the series of processing steps is complete.

As explained above, the automatic control device of this embodiment either deploys an airbag or moves the front hood from the stop position to the lifted position when the intensity of the collision sound is at or above the third reference value. This can ensure the safety of passengers in the vehicle or pedestrians that have collided with the vehicle. The automatic control device of this embodiment exhibits the same effect as the first embodiment.

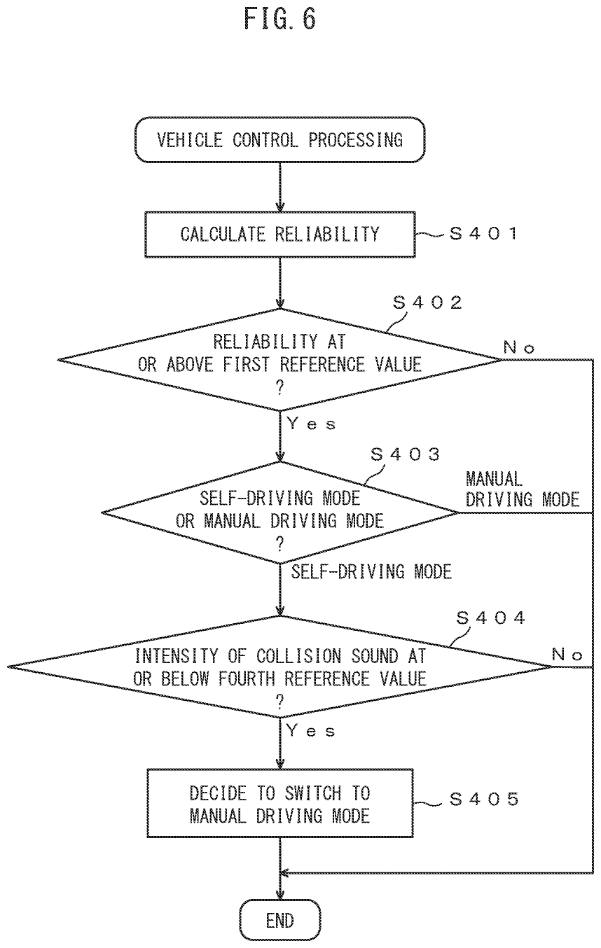

FIG. 6 is an example of an operation flow chart for vehicle control processing by the automatic control device of the fourth embodiment. Vehicle control processing by the automatic control device 11 will be described below with reference to FIG. 6. The automatic control device 11 carries out vehicle control processing according to the operation flow chart shown in FIG. 6, at a vehicle control time having a predetermined cycle.

Processing in steps S401 to S403 and S405 of this embodiment is the same as steps S101 to S104 described above. For this embodiment, the processing of step S404 is added between step S403 and step S405.

When the driving mode of the vehicle 10 is self-driving mode (step S403-self-driving mode), the determining unit 233 determines whether or not the intensity of the collision sound is at or below the fourth reference value based on the sound electrical signal acquired from the microphone 2 (step S404).

When the reliability is at or above the first reference value (step S402-Yes) and the intensity of the collision sound is at or below the fourth reference value (step S404-Yes), it is estimated that the vehicle 10 has collided with a small object such as a small stone. The fourth reference value may be a collision sound intensity produced when a small object such as a small stone has collided with the vehicle 10. The fourth reference value may be in the range of 50 to 60 decibels, for example.

When the intensity of the collision sound is at or below the fourth reference value (step S404-Yes), the deciding unit 234 decides to transfer the driving mode of the vehicle 10 from self-driving mode to manual driving mode (step S104), and the series of processing steps is complete.

When it has been estimated that the vehicle 10 has collided with a small object such as a small stone, main driving of the vehicle 10 is transferred to the driver for judgment of the conditions by the driver. If the vehicle 10 is decelerated or stopped after the vehicle 10 has collided with even a small object such as a small stone 51, the potential effect on traveling of another vehicle 60 following the vehicle 10 may outweigh ensuring safety for the vehicle 10.

When the reliability is not at or above the first reference value (step S402-No), or when the driving mode of the vehicle 10 is manual driving mode (step S403-manual driving mode), or when the intensity of the collision sound is not at or below the fourth reference value (step S404-No), the series of processing steps is complete.

When the intensity of the collision sound is not at or below the fourth reference value (step S404-No), the driving mode of the vehicle 10 remains in self-driving mode. Since the reliability is at or above the first reference value (step S402-Yes), the control unit 231 determines that the vehicle 10 has collided with an object, and the vehicle 10 may be driven to decelerate or to stop.

As explained above, the automatic control device of the embodiment allows a driver to take action in response to collision between the vehicle and an object when the intensity of the collision sound is at or below the fourth reference value. The vehicle can thus be properly driven under the judgment of the driver when the vehicle 10 has collided with a small object such as a small stone. The automatic control device of this embodiment exhibits the same effect as the first embodiment.

The vehicle control device, the computer program for vehicle control and the method for controlling a vehicle according to the embodiment described above may incorporate appropriate modifications that are still within the gist of the disclosure. Moreover, the technical scope of the disclosure is not limited to these embodiments, and includes the present disclosure and its equivalents as laid out in the Claims. The content explained for any one of the embodiments also applies to the other embodiments as well.

For example, each embodiment described above had one microphone and one airbag installed in the vehicle. However, the microphones may be installed on the left and right of the vehicle, and airbags may be installed at the driving seat and passenger seat in the vehicle cabin.

For the third embodiment, when it has been decided to deploy an airbag, the airbag deployed may be the one on the same side as the microphone in which a collision sound of intensity at or above the third reference value has been input.

1. A vehicle control device comprising:
a processor configured to
detect collision sound produced by collision between a vehicle and an object based on a sound signal acquired from a sound sensor, and calculate reliability of the detected collision sound,
determine whether the reliability is at or above a first reference value,
determine whether a driving mode of the vehicle is a first driving mode in which a degree to which a driver participates in driving is low, or a second driving mode in which the degree to which the driver participates in driving is higher than the first driving mode, and
decide to transfer the driving mode of the vehicle to the second driving mode when it has been determined that the reliability is at or above the first reference value and it has been determined that the driving mode of the vehicle is the first driving mode.

2. The vehicle control device according to claim 1, wherein the processor is further configured to
determine whether the reliability is at or above a second reference value that is larger than the first reference value, and
decide to decelerate the vehicle when it has been determined that the reliability is at or above the first reference value, it has been determined that the driving mode of the vehicle is the first driving mode, and it has been determined that the reliability of the collision sound is at or above the second reference value.

3. The vehicle control device according to claim 1, wherein the processor is further configured to
determine whether intensity of the collision sound is at or above a third reference value based on the sound signal acquired from the sound sensor, and
decide to deploy an airbag or to move the front hood from the stop position to a lifted position when it has been determined that the reliability is at or above the first reference value, it has been determined that the driving mode of the vehicle is the first driving mode, and it has been determined that the intensity of the collision sound is at or above the third reference value.

4. The vehicle control device according to claim 1, wherein the processor is further configured to
determine whether intensity of the collision sound is at or below the fourth reference value based on the sound signal acquired from the sound sensor, and
decide to transfer the driving mode of the vehicle to the second driving mode when it has been determined that the reliability is at or above the first reference value, it has been determined that the driving mode of the vehicle is the first driving mode, and it has been determined that the intensity of the collision sound is at or below the fourth reference value.

5. A computer-readable, non-transitory storage medium storing a computer program for controlling a vehicle which causes a processor to execute a process, the process comprising:
detecting collision sound produced by collision between a vehicle and an object based on a sound signal acquired from a sound sensor, and calculating reliability of the detected collision sound;
determining whether the reliability is at or above a first reference value;
determining whether a driving mode of the vehicle is a first driving mode in which a degree to which a driver participates in driving is low, or a second driving mode in which the degree to which the driver participates in driving is higher than the first driving mode; and
deciding to transfer the driving mode of the vehicle to the second driving mode when it has been determined that the reliability is at or above the first reference value and it has been determined that the driving mode of the vehicle is the first driving mode.

6. A method for controlling a vehicle carried out by a vehicle control device, and the method comprising:
detecting collision sound produced by collision between a vehicle and an object based on a sound signal acquired from a sound sensor, and calculating reliability of the detected collision sound;
determining whether the reliability is at or above a first reference value;
determining whether a driving mode of the vehicle is a first driving mode in which a degree to which a driver participates in driving is low, or a second driving mode in which the degree to which the driver participates in driving is higher than the first driving mode; and
deciding to transfer the driving mode of the vehicle to the second driving mode when it has been determined that the reliability is at or above the first reference value and it has been determined that the driving mode of the vehicle is the first driving mode.
